(19) United States
(12) Patent Application Publication
(10) Pub. No.: US 2015/0212532 A1
(43) Pub. Date: Jul. 30, 2015

(54) CONTROL SYSTEM CAPABLE OF CHANGING THE STATE OF AN ELECTRICAL APPLIANCE ACCORDING TO EXCEPTIONAL CONDITIONS

(71) Applicant: D-LINK CORPORATION, TAIPEI CITY (TW)

(72) Inventors: Wei-Chung HSU, Taipei City (TW); Ming-Han LIU, Taipei City (TW); Jun-Hao HUANG, Taipei City (TW); Jia-Jun CHEN, Taipei City (TW)

(73) Assignee: D-LINK CORPORATION, TAIPEI CITY (TW)

(21) Appl. No.: 14/308,187

(22) Filed: Jun. 18, 2014

(30) Foreign Application Priority Data
Jan. 28, 2014 (TW) 103103149

(51) Int. Cl. G05F 1/66; G05B 15/02

(52) U.S. Cl. CPC G05F 1/66; G05B 15/02

(57) ABSTRACT

The present invention is to provide a control system, which includes a plurality of switch devices each electrically connected between an electrical appliance and a power supply unit for turning on or off the electrical appliance, and a processing server respectively connected to the switch devices and capable of turning the switch device into a turned-on or turn-off state at a predetermined time according to a time schedule stored therein. In addition, the processing server can generate an exception time data when determining an exceptional condition (e.g., a specific event took place, a user did not leave home on time, or the user turned on the electrical appliance on his or her own initiative) occurs, and then change the state of each switch device preferentially according to the exception time data, so as to adjust the time schedule in a timely manner upon determining the occurrences of different exceptional conditions.

### FIELD OF THE INVENTION

The present invention relates to a control system, more particularly to a control system which includes a plurality of switch devices each electrically connected to an electrical appliance and capable of turning on or off the electrical appliance, and a processing server respectively connected to the switch devices and capable of turning the switch device into a turned-on or turn-off state at a predetermined time according to time schedule stored therein, wherein the processing server can generate an exception time data when determining an exceptional condition (e.g., a specific event took place, a user did not leave home on time, or the user turned on the electrical appliance on his or her own initiative) occurs, and then change the state of each switch device preferentially according to the exception time data, so as to adjust the time schedule in a timely manner upon determining the occurrences of different exceptional conditions.

### BACKGROUND OF THE INVENTION

With the rapid development of economy and the improvement of people's living standards, more and more electrical appliances—such as televisions, refrigerators, air conditioners, and electric radiators—have become essential to each household. And with the prevalence of such electrical appliances, household electricity consumption has risen year by year. This is why governments around the globe have endeavored to promote the concept of “energy saving and carbon dioxide reduction”, calling on the general public to avoid unnecessary electricity-consuming activities. The goal is to reduce the greenhouse gases produced by power companies during power generation and thereby contribute to environmental protection. In order for the public to know exactly the amount of electricity consumed by each electrical appliance, the market is now supplied with electricity management devices designed to record and calculate the power consumption of electrical appliances, assisting users in properly managing their electricity-using habits.

Please refer to FIG. 1 for a conventional electricity management device 1. The electricity management device 1 has a plug 11 on one side and a power socket 12 and a display screen 13 on the other side. Once the plug 11 is connected to a power supply socket 10 and the power socket 12 is connected to an electrical appliance, the processing unit in the electricity management device 1 detects the electricity currently consumed by the electrical appliance, generates electricity consumption data by calculation, and displays the electricity consumption data on the display screen 13, allowing the user to know the amount of electricity actually consumed by the electrical appliance. If it is found that the electrical appliance consumes a considerable amount of electricity in the standby mode, the user may adjust his or her electricity-using habits accordingly and unplug the electrical appliance when it is not in use, thereby reducing unnecessary electricity output.

While the electricity management device 1 can help the user calculate the electricity consumption data of each electrical appliance under different circumstances, chances are the number of types and the number of electrical appliances in the surroundings are so great that the user simply forgets to unplug some of the electrical appliances that are not in use. As a solution, the development of “intelligent electricity management services” is under way to assist in the management of various electrical appliances. For example, a user may establish a set of calendar data (e.g., using Google Calendar) according to his or her daily routines in order for a mobile device such as a mobile phone or a tablet computer to generate an alert message at each time point in the calendar data, alerting the user to confirm if all the electrical appliances that are not in use are unplugged. Apart from that, a central control system has been developed to automatically control the on and off of each electrical appliance according to the aforesaid calendar data.

Nevertheless, the “intelligent electricity management services” lack flexibility in practical use. Taking the alert messages for example, although the user can know, by the alert function of a mobile device, the electrical appliances that need unplugging, it is necessary for the user to unplug each of those appliances by hand, which is extremely inconvenient. As to the central control system, although its automatic control over each electrical appliance seems to greatly simply the user's actions, the fact that the user's daily schedules may vary (e.g., work days vs. holidays) and may be interrupted by exceptional events (e.g., a dinner gathering at short notice that delays the user's coming home) requires the user to input the exceptional items into the central control system according to the differences in his or her daily schedules, which is also inconvenient.

Hence, the inventor of the present invention envisioned the design of a control system which not only can control the on and off of each electrical appliance according to the user's daily routines, but also can dynamically detect the occurrence of any exceptional event and adjust its own control behaviors accordingly. The issue to be addressed by the present invention, therefore, is to conduct research and tests on related technologies and design a control system that caters for all the aforesaid needs.

### BRIEF SUMMARY OF THE INVENTION

In view of the fact that the conventional electricity management services require frequent setting and are not intuitive or convenient enough, the inventor of the present invention incorporated years of practical experience into extensive research, repeated tests, and improvements and finally succeeded in developing a control system capable of changing the state of an electrical appliance according to exceptional conditions. The control system disclosed herein is intended to provide more user-friendly and more flexible control.

It is an objective of the present invention to provide a control system capable of changing the state of an electrical appliance according to exceptional conditions. The control system includes a plurality of switch devices and a processing server. Each of the switch devices (e.g., each of a plurality of intelligent power sockets) is electrically connected to an electrical appliance (e.g., a television, an electric lamp, or an air conditioner). When in a turned-on state, each of the switch devices delivers electricity from a power supply unit to the corresponding electrical appliance and thereby drives the electrical appliance into operation. When in a turned-off state, each of the switch devices cuts off the electrical connection between the power supply unit and the corresponding electrical appliance and thereby stops the operation of the electrical appliance. The processing server is connected to the switch devices either wirelessly (e.g., via WiFi) or in a wired manner (e.g., via power lines). The processing server stores a first schedule which includes plural entries of first electrical appliance data and plural entries of first time data. Each entry of the first electrical appliance data corresponds to one of the switch devices and the corresponding electrical appliance. Each entry of the first time data is composed of at least one turn-on time and at least one turn-off time. Upon determining that the current time matches the turn-on time in a certain entry of the first time data, the processing server sends a start message to the corresponding switch device and thereby brings the switch device into the turned-on state. Upon determining that the current time matches the turn-off time in a certain entry of the first time data, the processing server sends a stop message to the corresponding switch device and thereby brings the switch device into the turned-off state. Upon determining that an exceptional condition occurs (e.g., when it is determined through a network that a specific event took place, that the user did not leave home on time, or that the user turned on an electrical appliance on his or her own initiative), the processing server generates exception time data and changes the turned-on state or the turned-off state of each switch device preferentially according to the exception time data. Once the processing server determines that the time period defined by the exception time data has ended, the processing server continues to control the switch devices according to the first time data. As the processing server can adjust the on and off of different electrical appliances in a timely manner upon determining the occurrences of different exceptional conditions, the user does not have to modify the first schedule on a daily basis according to the changes in everyday schedules. In other words, the control system features enhanced user-friendliness.

Another objective of the present invention is to provide the foregoing control system, wherein the processing server can connect to a cloud server (e.g., a Google server) through the Internet in order to receive a second schedule (e.g., a Google cloud calendar) from the cloud server. Moreover, upon determining that the second schedule does not match the first schedule, the processing server generates the exception time data according to the second schedule and controls the corresponding switch device(s) according to the exception time data.

Still another objective of the present invention is to provide the foregoing control system, wherein the processing server can connect to a mobile communication device wirelessly (e.g., via WiFi). The processing server can set the time for which it remains connected to the mobile communication device as the exception time data and, during the time period defined by the exception time data, postpone sending the start message or stop message. Only when the processing server determines that the time period defined by the exception time data has ended (i.e., when the connection between the processing server and the mobile communication device is terminated) will the processing server send the start message or stop message to the corresponding switch device(s) (e.g., to turn off an electric lamp only when it is determined that the user has left home). As such, the control system is in operation only when the user has left home.

Yet another objective of the present invention is to provide the foregoing control system, wherein each of the electrical appliances sends an exception message to the processing server when manually turned on, allowing the processing server to record the time for which the electrical appliance is used and set the time as the exception time data. Also, the processing server can send the start message to the switch device(s) adjacent to the electrical appliance manually turned on (e.g., to turn on a stereo system and an air conditioner when it is determined that a television is turned on). Once it is determined by the processing server that the time period defined by the exception time data has ended, the processing server sends the stop message to the switch device(s) adjacent to the electrical appliance manually turned on.

### BRIEF DESCRIPTION OF THE SEVERAL VIEWS OF THE DRAWINGS

The objectives, as well as the technical content and operating modes, of the present invention will be best understood by referring to the following detailed description of some illustrative embodiments in conjunction with the accompanying drawings, in which:

FIG. 1 schematically shows a conventional electricity management device;

FIG. 2 schematically shows the first preferred embodiment of the control system of the present invention;

FIG. 3 schematically shows the first schedule in the control system of the present invention;

FIG. 4 schematically shows the second schedule in the control system of the present invention; and

FIG. 5 schematically shows the details of the second schedule in the control system of the present invention.

### DETAILED DESCRIPTION OF THE INVENTION

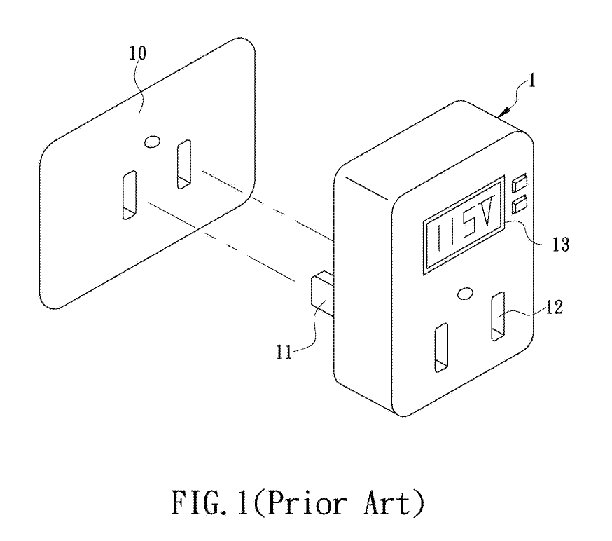

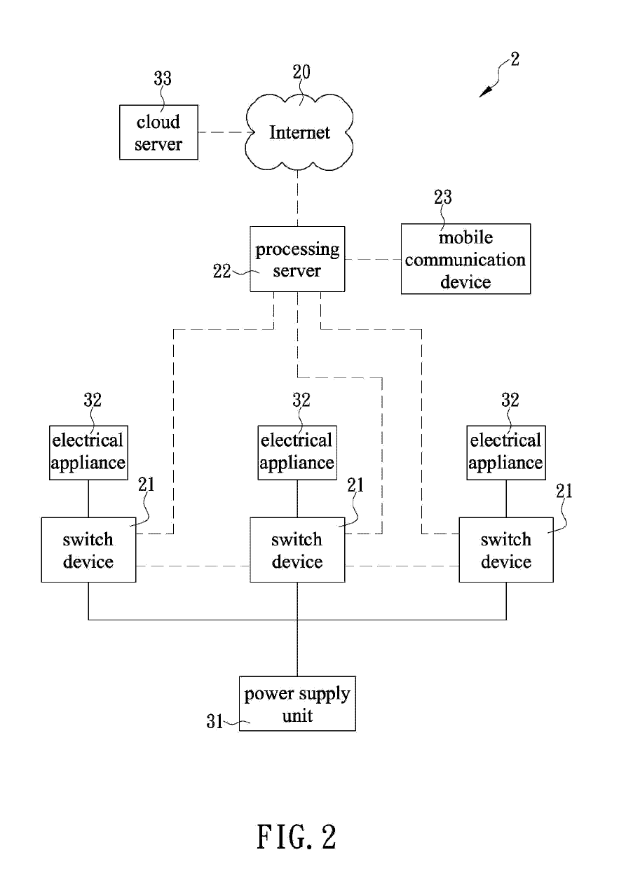

The present invention discloses a control system capable of changing the state of an electrical appliance according to exceptional conditions. Referring to FIG. 2 for the first preferred embodiment of the present invention, the control system 2 includes a plurality of switch devices 21 and a processing server 22. In this embodiment, the switch devices 21 are intelligent power sockets similar in appearance to the electricity management device 1 shown in FIG. 1 (with the display screen 13 being a non-essential component) and can each be connected to a power supply socket in order to receive the electricity delivered from a power supply unit 31. Each switch device 21 can be connected with an electrical appliance 32 and serve as a bridge between the electrical appliance 32 and the power supply unit 31. It should be pointed out that the switch devices 21 are not limited in form to sockets; each switch device 21 may alternatively be a power supply component in an electrical appliance 32 or be designed as a power strip, provided that each switch device 21 is configured to control the on and off of an electrical appliance 32 according to the present invention.

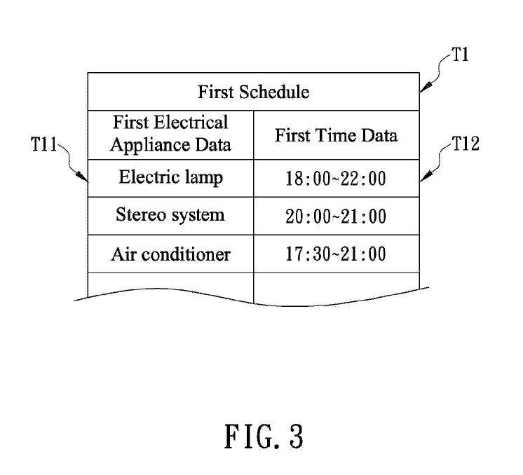

Referring to FIG. 2 and FIG. 3, the processing server 22 is connected to the switch devices 21 either wirelessly (e.g., via WiFi) or in a wired manner (e.g., via power lines). The processing server 22 stores a first schedule T1 which includes plural entries of first electrical appliance data T11 and plural entries of first time data T12. Each entry of the first electrical appliance data T11 corresponds to one of the switch devices 21 and a corresponding one of the electrical appliances 32 (e.g., an electric lamp or an air conditioner). Each entry of the first time data T12 corresponds to one entry of the first electrical appliance data T11 and is composed of at least one first turn-on time and at least one first turn-off time. (In FIG. 3 for example, the first turn-on time and the first turn-off time corresponding to the “electric lamp” are “18:00” and “22:00” respectively.) In this embodiment, the first schedule T1 is set directly by the user (e.g., via an APP of a smart phone) and is stored in the processing server 22. In other preferred embodiments of the present invention, however, the processing server 22 may connect to a cloud server 33 through the Internet 20 in order to obtain the first schedule T1 (e.g., a cloud calendar of Google).

Upon determining that the current time matches a certain first turn-on time in the first schedule T1, the processing server 22 sends a start message to the corresponding switch device 21 such that the switch device 21 enters a turned-on state, in which the electricity provided by the power supply unit 31 is delivered to the corresponding electrical appliance 32 (e.g., an electric lamp in a room is turned on at 19:00 every day). Upon determining that the current time matches a certain turn-off time in the first schedule T1, the processing server 22 sends a stop message to the corresponding switch device 21 to bring the switch device 21 into a turned-off state, in which electrical connection between the power supply unit 31 and the corresponding electrical appliance 32 is cut off (e.g., the electrical lamp in the room is turned off at 23:00 every day).

The major improvement made by the present invention is this: upon determining that an exceptional condition occurs, the processing server 22 generates corresponding exception time data and changes the turned-on state or the turned-off state of each switch device 21 preferentially according to the exception time data. The processing server 22 will not control the switch devices 21 according to the first time data T12 until the time period defined by the exception time data has ended. To further demonstrate the possible “exceptional conditions” and how the control system 2 deals with them, some relatively common examples are given below.

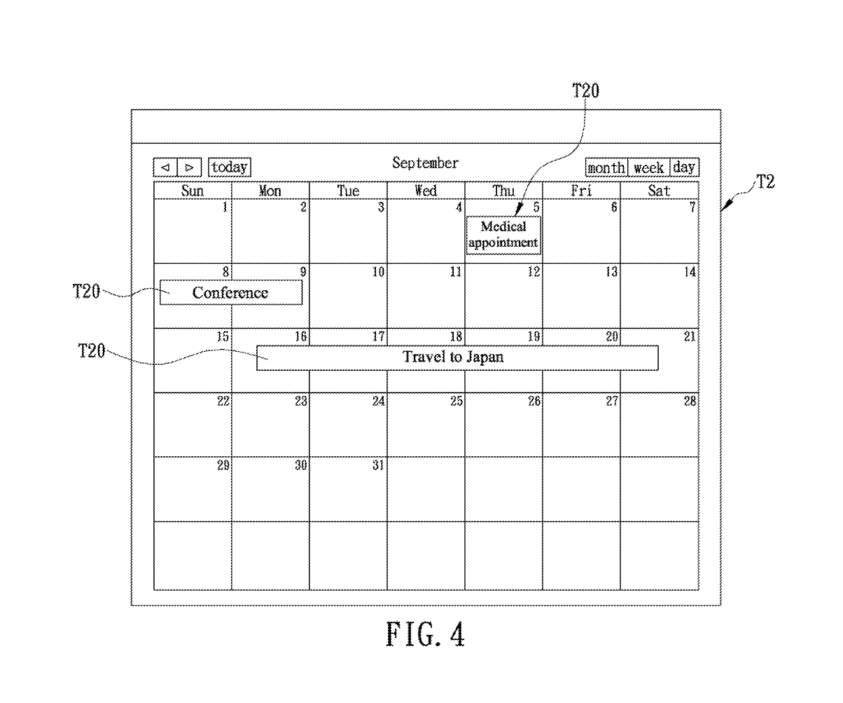

In the first preferred embodiment of the present invention, referring to FIG. 2 to FIG. 4, the user may set an additional second schedule T2 (e.g., a cloud calendar provided by Google) in the cloud server 33, and the processing server 22 can connect to the cloud server 33 through the Internet 20 to obtain the second schedule T2 and compare the second schedule T2 with the first schedule T1. If it is determined by the processing server 22 that the second schedule T2 does not match the first schedule T1, the processing server 22 will generate the exception time data according to the second schedule T2 and control the switch devices 21 according to the exception time data. For example, referring to FIG. 4, the second schedule T2 contains plural entries of event data T20. With regard to the event data T20: “travel to Japan, September 16-21”, the processing server 22 can determine after analysis that “all the electrical appliances should be turned off, 0:00 to 24:00, from September 16 through 21”. With regard to the event data T20: “medical appointment in the evening, September 5”, the processing server 22 can determine after analysis that “all the electrical appliances should be turned off, 18:00 to 21:00, on September 5”.

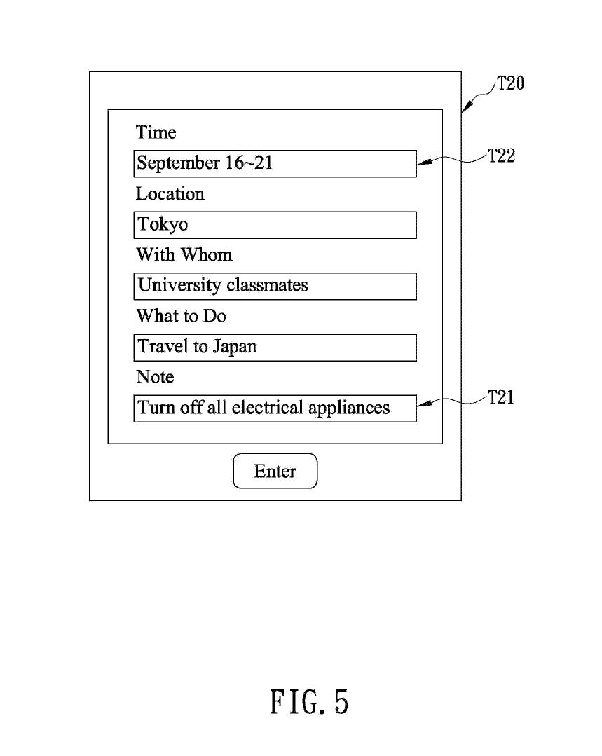

To enhance control precision, referring to FIG. 2 to FIG. 5, the second schedule T2 may include plural entries of second electrical appliance data T21 and plural entries of second time data T22. Each entry of the second electrical appliance data T21 corresponds to one of the switch devices 21 and the corresponding electrical appliance 32. Each entry of the second time data T22 corresponds to one entry of the second electrical appliance data T21 and defines a time period. Upon determining that the a certain entry of the second time data T22 in the second schedule T2 does not match a related entry of the first time data T12 in the first schedule T1 (e.g., with the second schedule T2 reading “medical appointment, 18:00 to 21:00; turn off all the electrical appliances in the house during the same time period”, and the first schedule T1 reading “turn on the television, 20:00 to 22:00”), the processing server 22 sets that particular entry of the second time data T22 as the exception time data and controls the switch devices 21 preferentially according to the exception time data.

In the first preferred embodiment, the role of the cloud server 33 may be replaced by a smart phone. For example, the processing server 22 is configured to detect the alarm clock function of a smart phone, obtain the second schedule T2 (e.g., the alarm clock set to go off at 7:00) by analysis, and control the corresponding switch device(s) 21 and electrical appliance(s) 32 (e.g., the alarm clock, a radio, and/or en electric lamp) according to the second schedule T2.

In the second preferred embodiment of the present invention, the control system 2 can be used in conjunction with a mobile communication device 23 (e.g., a smart phone), and the processing server 22 can detect the mobile communication device 23 via radio signals (e.g., the processing server 22 can connect to the mobile communication device 23 via WiFi by a router function) in order to obtain more detailed information through the mobile communication device 23. More specifically, upon determining that the mobile communication device 23 is detected, the processing server 22 sets the time for which it is connected with the mobile communication device 23 as the exception time data. During the time period defined by the exception time data, the processing server 22 postpones sending the start message and/or the stop message. Only when the processing server 22 determines that the mobile communication device 23 can no longer be detected (i.e., when the connection between the processing server 22 and the mobile communication device 23 is terminated) will the processing server 22 determine that the time period defined by the exception time data ends. And only then will the processing server 22 send the postponed start message and/or stop message to the corresponding switch device(s). This function is so designed that, should the user fail to follow his or her daily routines due to an incident (e.g., when the user overslept and left home later than usual), the processing server 22 will suspend in a timely manner the corresponding control actions that are scheduled to be taken (e.g., an electric lamp or a radio will not be turned off until the user leaves home).

In the second preferred embodiment of the present invention, the control system 2 will not work until the user leaves home, or the user can make use of the APP function of a smart phone so that the control system 2 will not be activated unless the user's mobile communication device 23 logs on to (or logs out from) the processing server 22. For example, the user may connect to the processing server 22 at any time through the Internet 20 and choose whether or not the control system 2 should be in charge of managing the electrical appliances 32. In the third preferred embodiment of the present invention, if the user manually turns on one of the electrical appliances 32 (or the corresponding switch device 21) on his or her own initiative, the electrical appliance 32 will send an exception message to the processing server 22, and the processing server 22 will consequently determine that the user has started an exceptional condition on his or her own. The processing server 22 will record the time for which the electrical appliance 32 is in operation and set the time as the exception time data. (For example, if the user turns on a television at 15:00, the processing server 22 will record “15:00” as a second turn-on time in the exception time data.) Additionally, the processing server 22 will send the start message to the switch device(s) 21 adjacent to the electrical appliance 32 just turned on, thereby starting another electrical appliance 32 or other electrical appliances 32 that are adjacent to the electrical appliance 32 manually turned on. (e.g., the processing server 22 may set a correspondence relationship in the first electrical appliance data T11 in order to correctly determine the adjacent electrical appliance(s) 32 by analysis). Once the manually turned on electrical appliance 32 (or the corresponding switch device 21) is manually turned off by the user, the electrical appliance 32 sends an exception resolved message to the processing server 22 so as for the processing server 22 to determine that the time period defined by the exception time data has ended. (For example, if the user turns off the television at 17:00, the processing server 22 will record “17:00” as a second turn-off time in the exception time data.) The processing server 22 also sends the stop message to the switch device(s) 21 turned on by the control system 2 to simultaneously turn off the electrical appliance(s) 32 previously started by the control system 2. (For example, if a stereo system and an electric lamp were turned on by the control system as the user turned on the television, the processing server will turn off the stereo system and the electric lamp as soon as the user turned off the television.)

In addition, each switch device 21 may be provided therein with a wireless module so that the switch devices 21 can connect to and interact intelligently with one another through the wireless modules. For example, when the user manually turns on a television, the switch device 21 mounted on the television sends an exception message to the switch device 21 of an adjacent electrical appliance 32 (e.g., a stereo system) to turn on the electrical appliance 32. By the same token, when the user manually turns off the television, the switch device 21 of the television sends an exception resolved message to the switch device 21 of the adjacent electrical appliance 32 to turn off the electrical appliance 32.

Furthermore, in other preferred embodiments of the present invention, each switch device 21 may be provided therein with a measuring device for detecting the amount of electricity consumed by, the amount of heat generated by, or the operation time of the corresponding electrical appliance 32. If the electricity consumed, the heat generated, or the operation time is determined to exceed a predetermined value (e.g., exceeding 40 degrees Celsius or three hours of uninterrupted use), the switch device 21 whose measuring device made such a detection sends a warning message to the processing server 22, which in turn relays the warning message to the mobile communication device 23. Thus, an additional protection or management mechanism is established.

While the invention herein disclosed has been described by means of specific embodiments, numerous modifications and variations could be made thereto by those skilled in the art without departing from the scope of the invention set forth in the claims.

What is claimed is:

1. A control system capable of changing the state of an electrical appliance according to exceptional conditions, comprising:
a plurality of switch devices each electrically connected to an electrical appliance, wherein each of the switch devices when in a turned-on state delivers electricity from a power supply unit to a corresponding one of the electrical appliances, and each of the switch devices when in a turned-off state cuts off electrical connection between the power supply unit and the corresponding electrical appliance; and
a processing server connected to the switch devices either wirelessly or in a wired manner and storing a first schedule, the first schedule including plural entries of first electrical appliance data and plural entries of first time data, each said entry of the first electrical appliance data corresponding to one of the switch devices and the corresponding electrical appliance, each said entry of the first time data being composed of at least one turn-on time and at least one turn-off time, wherein upon determining that a current time matches a said turn-on time in a said entry of the first time data, the processing server sends a start message to a corresponding one of the switch devices, thus bringing the switch device into the turned-on state; upon determining that the current time matches a said turn-off time in a said entry of the first time data, the processing server sends a stop message to a corresponding one of the switch devices, thus bringing the switch device into the turned-off state; upon determining that an exceptional condition occurs, the processing server generates exception time data and changes the turned-on state or the turned-off state of each of the switch devices preferentially according to the exception time data; and the processing server will not control the switch devices according to the first time data until it is determined by the processing server that a time period defined by the exception time data has ended.

2. The control system of claim 1, wherein the processing server is configured to connect to a cloud server through the Internet so as to receive a second schedule from the cloud server, and upon determining that the second schedule does not match the first schedule, the processing server generates the exception time data according to the second schedule and controls a corresponding one or corresponding ones of the switch devices according to the exception time data.

3. The control system of claim 2, wherein the second schedule includes plural entries of second electrical appliance data and plural entries of second time data, each said entry of the second electrical appliance data corresponding to one of the switch devices and the corresponding electrical appliance, each said entry of the second time data corresponding to a said entry of the second electrical appliance data; and upon determining that a said entry of the second time data does not match a related said entry of the first time data, the processing server sets the entry of the second time data as the exception time data.

4. The control system of claim 1, wherein the processing server is configured to connect to a mobile communication device wirelessly, to set a time for which the processing server remains connected to the mobile communication device as the exception time data, to postpone sending the start message or the stop message during the time period defined by the exception time data, and to not send the start message or the stop message to a corresponding one or corresponding ones of the switch devices until it is determined by the processing server that the time period defined by the exception time data has ended.

5. The control system of claim 1, wherein when one of the electrical appliances is manually turned on, the electrical appliance manually turned on sends an exception message to the processing server in order for the processing server to record a time for which the electrical appliance manually turned on is used, set the time for which the electrical appliance manually turned on is used as the exception time data, send the start message to a said switch device or said switch devices which are adjacent to the electrical appliance manually turned on, thereby starting another said electrical appliance or other said electrical appliances which are adjacent to the electrical appliance manually turned on, and upon determining that the time period defined by the exception time data has ended, send the stop message to the switch device or the switch devices which are adjacent to the electrical appliance manually turned on.

6. The control system of claim 1, wherein each of the switch devices is separately electrically connected to and is provided between the power supply unit and the corresponding electrical appliance.

7. The control system of claim 2, wherein each of the switch devices is separately electrically connected to and is provided between the power supply unit and the corresponding electrical appliance.

8. The control system of claim 3, wherein each of the switch devices is separately electrically connected to and is provided between the power supply unit and the corresponding electrical appliance.

9. The control system of claim 4, wherein each of the switch devices is separately electrically connected to and is provided between the power supply unit and the corresponding electrical appliance.

10. The control system of claim 5, wherein each of the switch devices is separately electrically connected to and is provided between the power supply unit and the corresponding electrical appliance.

11. The control system of claim 6, wherein each of the switch devices is configured to detect an amount of electricity consumed, and an amount of heat generated, by the corresponding electrical appliance and, upon determining that the amount of electricity or the amount of heat exceeds a predetermined value, to send a warning message to the processing server.

12. The control system of claim 7, wherein each of the switch devices is configured to detect an amount of electricity consumed, and an amount of heat generated, by the corresponding electrical appliance and, upon determining that the amount of electricity or the amount of heat exceeds a predetermined value, to send a warning message to the processing server.

13. The control system of claim 8, wherein each of the switch devices is configured to detect an amount of electricity consumed, and an amount of heat generated, by the corresponding electrical appliance and, upon determining that the amount of electricity or the amount of heat exceeds a predetermined value, to send a warning message to the processing server.

14. The control system of claim 9, wherein each of the switch devices is configured to detect an amount of electricity consumed, and an amount of heat generated, by the corresponding electrical appliance and, upon determining that the amount of electricity or the amount of heat exceeds a predetermined value, to send a warning message to the processing server.

15. The control system of claim 10, wherein each of the switch devices is configured to detect an amount of electricity consumed, and an amount of heat generated, by the corresponding electrical appliance and, upon determining that the amount of electricity or the amount of heat exceeds a predetermined value, to send a warning message to the processing server.
